(19) United States
(12) Patent Application Publication
(10) Pub. No.: US 2026/0328700 A1
(43) Pub. Date: Oct. 22, 2026

(54) OPTICAL SYSTEM CAPABLE OF EASILY INSPECTING A LARGE AREA AND OBSERVATION APPARATUS INCLUDING THE SAME

(71) Applicant: PSI System Inc., Hwaseong-si (KR)

(72) Inventor: Yeong Hwa RYU, Goyang-si (KR)

(73) Assignee: PSI System Inc., Hwaseong-si (KR)

(21) Appl. No.: 19/692,343

(22) Filed: May 29, 2026

Related U.S. Application Data
(63) Continuation of application No. PCT/KR2024/011961, filed on Aug. 12, 2024.

(30) Foreign Application Priority Data
Dec. 1, 2023 (KR) 10-2023-0172317
Aug. 1, 2024 (KR) 10-2024-0102305

(51) Int. Cl. G01N 21/88

(52) U.S. Cl. CPC G01N 21/8806; G01N 21/8851; G01N 2201/061

(57) ABSTRACT

In an observation apparatus for observing an observation target object, there is provided an observation apparatus includes a plurality of light sources for irradiating light for observation of an observation region; a plurality of imaging systems, each configured to direct light to the observation region or to the observation region and to a reference mirror provided in the imaging system to generate interference light including optical characteristics of the observation target object; a plurality of image sensors for receiving interference light interfered in each imaging system and sensing optical characteristics of the observation target object; and a controller for controlling operation of each light source and observing the observation target object based on sensing values of each image sensor. Each imaging system is implemented such that a size of an image formed on the image sensor is larger than an image of the observation region.

### CROSS-REFERENCE TO RELATED APPLICATIONS

The present application is a continuation of International Application No. PCT/KR2024/011961 filed on Aug. 12, 2024, which claims priority under 35 U.S.C. § 119(a) to Korean Patent Application No. 10-2023-0172317, filed in the Korean Intellectual Property Office on Dec. 1, 2023, and Korean Patent Application No. 10-2024-0102305, filed in the Korean Intellectual Property Office on Aug. 1, 2024, the entire disclosure of which is incorporated herein by reference.

### BACKGROUND

### 1. Technical Field

The present embodiment relates to an optical system capable of easily inspecting a large area of an observation target object, and an observation apparatus including the same.

### 2. Related Art

The content described in this section merely provides background information regarding the present embodiment and does not constitute prior art.

An observation apparatus has various purposes, such as determining whether an abnormality has occurred, and is a device for inspecting an observation target object (a surface thereof, etc.) or an observation region. The observation apparatus uses either a magnifying optical system having a magnification greater than 1, in which the size of an image formed on an image sensor or the like is larger than the image of the observation target object (or the observation region), or a reducing optical system having a magnification less than 1, in which the size of an image formed on an image sensor or the like is smaller than the image of the observation target object (or the observation region).

Examples of a reducing optical system and a magnifying optical system are illustrated in FIGS. 17A and 17B.

FIG. 17A is a diagram illustrating a configuration of an apparatus for observing an observation target object using a reducing optical system, and FIG. 17B is a diagram illustrating a configuration of an apparatus for observing an observation target object using a magnifying optical system.

As illustrated in FIG. 17A, the observation region 1710 passes through the reducing optical system 1720, and an image is formed on an image sensor 1730 having a size smaller than the image of the observation region 1710. The observation apparatus can inspect the observation region 1710 using sensing values of the image sensor 1730.

At this time, if the observation apparatus intends to observe a plurality of observation regions 1710a and 1710b that are adjacent to each other within a single observation target object, the observation apparatus can observe the plurality of observation regions 1710a and 1710b without difficulty because it includes a reducing optical system.

On the other hand, as illustrated in FIG. 17B, the observation region passes through the magnifying optical system 1740, and an image is formed on an image sensor 1750 having a size larger than the image of the observation region 1710. Accordingly, the observation apparatus including the reducing optical system was able to observe the observation target object collectively by sensing the observation region 1710 at once and then performing a post-processing (image processing) step.

On the other hand, if the observation apparatus intends to observe a plurality of observation regions 1710a and 1710b that are adjacent to each other within a single observation target object, it has a problem as illustrated in FIG. 17B because it includes a magnifying optical system. As described above, since the size of the image sensor 1750 is larger than the image of the observation region 1710, a problem arises in that physical arrangement of the image sensors 1750a and 1750b for observing the aforementioned observation regions 1710a and 1710b becomes impossible.

Accordingly, when the observation region is smaller than the entire area of the observation target object, the conventional observation apparatus including a magnifying optical system has the inconvenience of having to observe the observation target object by moving the observation region one by one within the entire area of the observation target object. Accordingly, the conventional observation apparatus including a magnifying optical system has had considerable inconvenience in observing the observation target object.

### SUMMARY

An embodiment of the present invention has a purpose of providing an optical system capable of easily observing a large area even when having an observation region that is relatively narrower than the observation target object, and an observation apparatus including the same.

According to an aspect of the present embodiment, in an observation apparatus for observing an observation target object, there is provided an observation apparatus comprising: one or more light sources for irradiating light for observation of an observation region; a plurality of imaging systems, each configured to direct light to the observation region or to the observation region and to a reference mirror provided in the imaging system, to generate object light or interference light including optical characteristics of the observation target object; a plurality of image sensors for receiving light generated by each imaging system and sensing optical characteristics of the observation target object; and a controller for controlling operation of each light source, controlling operation of each image sensor, and observing the observation target object based on sensing values of each image sensor, wherein each imaging system is implemented such that a size of an image formed on the image sensor is larger than an image of the observation region.

According to an aspect of the present embodiment, each imaging system includes a deflection element for converting an optical path.

According to an aspect of the present embodiment, the image sensors are arranged so as not to physically overlap with each other.

According to an aspect of the present embodiment, the deflection element converts the path of light such that the image sensors are arranged so as not to physically overlap with each other, while each observation region is arranged to be spaced apart by a predetermined distance in a width direction and a length direction.

According to an aspect of the present embodiment, the deflection element may be implemented as a mirror, a diffraction grating, a prism, or a metasurface.

According to an aspect of the present embodiment, the controller controls operation of each image sensor in synchronization with a speed or a position at which the observation target object moves.

According to an aspect of the present embodiment, the controller is capable of observing an area equal to or greater than a predetermined reference value of the observation target object at once.

According to an aspect of the present embodiment, there is provided an observation system comprising: a stage for placing and moving an observation target object; and an observation apparatus for measuring optical characteristics of the observation target object by observing an observation region in synchronization with a speed or a position of the observation target object on the stage, wherein the observation apparatus comprises: one or more light sources for irradiating light for observation of an observation region; a plurality of imaging systems, each configured to direct light to the observation region or to the observation region and to a reference mirror provided in the imaging system, to generate object light or interference light including optical characteristics of the observation target object; a plurality of image sensors for receiving light generated by each imaging system and sensing optical characteristics of the observation target object; and a controller for controlling operation of each image sensor and observing the observation target object based on sensing values of each image sensor, wherein each imaging system is implemented such that a size of an image formed on the image sensor is larger than an image of the observation region.

According to an aspect of the present embodiment, the imaging systems are configured such that each observation region is arranged without gaps in one direction and is spaced apart by a predetermined distance in a direction perpendicular thereto.

According to an aspect of the present embodiment, there is provided an observation apparatus comprising an optical mask for receiving interference light that has passed through the imaging system and generating a plurality of phase-shifted interference patterns, wherein the optical mask comprises: an optical array for receiving interference light and inducing phase shifts at different angles inherently; and a circular polarization beam splitter for receiving light that has passed through the optical array, reflecting one circular polarization component and transmitting another circular polarization component.

According to an aspect of the present embodiment, the optical array is implemented as a geometric phase optical element to induce phase shifts with respect to the incident interference light.

According to an aspect of the present embodiment, the optical array is implemented as a structure having a metasurface, or implemented as a structure including liquid crystal.

According to an aspect of the present embodiment, the optical array separates the incident light into a polarization component identical to the incident light and an opposite polarization component.

According to an aspect of the present embodiment, the circular polarization beam splitter has a helical structural property (chirality).

According to an aspect of the present embodiment, the circular polarization beam splitter reflects a circular polarization component having the same rotational direction as the helical structure thereof among light incident thereon, and transmits a circular polarization component rotating in the opposite direction thereof.

According to an aspect of the present embodiment, in a method for an observation apparatus to detect optical characteristics of an observation target object, there is provided an optical characteristic detection method comprising: a first detection step of detecting interference patterns of object light and reference light that have passed through an optical mask; an acquisition step of acquiring a plurality of interference pattern images by grouping the interference patterns detected in the first detection step according to an optical axis rotation angle of geometric phase optical pixels; and a second detection step of detecting optical characteristics of the object light using the plurality of interference pattern images acquired in the acquisition step.

According to an aspect of the present embodiment, in an observation apparatus for observing an observation target object, there is provided an observation apparatus comprising: one or more light sources for irradiating light for observation of an observation region; a plurality of imaging systems, each configured to direct light to the observation region or to the observation region and to a reference mirror provided in the imaging system, to generate object light or interference light including optical characteristics of the observation target object; a plurality of image sensors for receiving light generated by each imaging system and sensing optical characteristics of the observation target object; a plurality of optical masks arranged in front of each image sensor on an optical path to receive interference light that has passed through each imaging system and generate a plurality of phase-shifted interference patterns; and a controller for controlling operation of each image sensor and observing the observation target object based on sensing values of each image sensor, wherein each optical mask comprises: an optical array for receiving interference light and inducing phase shifts at different angles inherently; and a circular polarization beam splitter for receiving light that has passed through the optical array, reflecting one circular polarization component and transmitting another circular polarization component.

According to an aspect of the present embodiment, in an observation apparatus for observing an observation target object, there is provided an observation apparatus comprising: one or more light sources for irradiating light for observation of an observation region; a plurality of imaging systems, each configured to direct light to the observation region or to the observation region and to a reference mirror provided in the imaging system, to generate object light or interference light including optical characteristics of the observation target object; a plurality of image sensors for receiving light generated by each imaging system and sensing optical characteristics of the observation target object; and a controller for controlling operation of each image sensor and observing the observation target object based on sensing values of each image sensor, wherein each imaging system is configured such that each observation region is arranged without gaps in one direction and is spaced apart by a predetermined distance in a direction perpendicular thereto.

According to an aspect of the present embodiment, the imaging system includes an objective lens.

According to an aspect of the present embodiment, the image sensor, the objective lens, and the observation region are arranged such that their centers are disposed on the same line or disposed at positions within a predetermined error range from the same line.

According to an aspect of the present embodiment, the objective lens has an area or diameter greater than a corresponding area or diameter of each of the image sensor and the observation apparatus.

According to an aspect of the present embodiment, the objective lens is arranged in parallel with an adjacent objective lens in one direction.

According to an aspect of the present embodiment, there is provided an observation system comprising: a stage for placing and moving an observation target object; and an observation apparatus for measuring optical characteristics of the observation target object by observing an observation region in synchronization with a speed or a position of the observation target object on the stage, wherein the observation apparatus comprises: one or more light sources for irradiating light for observation of an observation region; a plurality of imaging systems, each configured to direct light to the observation region or to the observation region and to a reference mirror provided in the imaging system, to generate object light or interference light including optical characteristics of the observation target object; a plurality of image sensors for receiving light generated by each imaging system and sensing optical characteristics of the observation target object; and a controller for controlling operation of each image sensor and observing the observation target object based on sensing values of each image sensor, wherein each imaging system is configured such that each observation region is arranged without gaps in one direction and is spaced apart by a predetermined distance in a direction perpendicular thereto.

According to an aspect of the present embodiment, the observation regions are arranged without gaps in a direction perpendicular to a direction in which the stage moves the observation target object, and arranged to be spaced apart by a predetermined distance in the direction in which the stage moves the observation target object.

According to an aspect of the present embodiment, the controller controls operation of each image sensor in synchronization with a speed of the stage or a position of the observation target object.

As described above, according to an aspect of the present embodiment, even when having an observation region that is relatively narrower than the observation target object, there is an advantage in that a large area can be easily observed.

### BRIEF DESCRIPTION OF THE DRAWINGS

FIG. 1 is a diagram illustrating an example of an observation system according to an embodiment of the present invention.

FIG. 2 is a diagram illustrating a configuration of an observation apparatus according to a first embodiment of the present invention.

FIGS. 3A and 3B are diagrams illustrating an implementation example of the observation apparatus according to the first embodiment of the present invention.

FIG. 4 is a diagram illustrating observation regions of the observation apparatus according to the first embodiment of the present invention.

FIGS. 5A-5D are diagrams illustrating a process of observing an observation target object by the observation apparatus according to the first embodiment of the present invention.

FIG. 6 is a diagram illustrating a configuration of an observation apparatus according to a second embodiment of the present invention.

FIG. 7 is a diagram illustrating a configuration of an optical mask according to the second embodiment of the present invention.

FIG. 8 is a diagram explaining optical characteristics of an optical array according to the second embodiment of the present invention.

FIGS. 9A and 9B are diagrams illustrating material characteristics of a material constituting the optical array according to the second embodiment of the present invention.

FIG. 10 is a diagram illustrating a structure of the optical array according to the second embodiment of the present invention.

FIG. 11 is a diagram illustrating a structure and chiral volume grating characteristics of a circular polarization beam splitter according to the second embodiment of the present invention.

FIG. 12 is a diagram explaining optical characteristics of the circular polarization beam splitter according to the second embodiment of the present invention.

FIG. 13 is a diagram explaining optical characteristics of the optical mask according to the second embodiment of the present invention.

FIG. 14 is a diagram illustrating an optical characteristic detection process of the observation apparatus according to the second embodiment of the present invention.

FIGS. 15A and 15B are diagrams illustrating a pixel structure of phase-shifted interference patterns detected by the image sensor according to the second embodiment of the present invention.

FIG. 16 is a flowchart illustrating a method for the observation apparatus to detect optical characteristics of an observation target object according to the second embodiment of the present invention.

FIGS. 17A and 17B are diagrams illustrating a configuration of an apparatus for observing an observation target object using a reducing optical system or a magnifying optical system.

FIGS. 18A and 18B are diagrams illustrating an implementation example of an observation apparatus according to a third embodiment of the present invention.

FIG. 19 is a diagram illustrating observation regions of the observation apparatus according to the third embodiment of the present invention.

FIGS. 20A-20D are diagrams illustrating a process of observing an observation target object by the observation apparatus according to the third embodiment of the present invention.

### DETAILED DESCRIPTION

Since the present disclosure may have various changes and various embodiments, specific embodiments are illustrated and described in the accompanying drawings. However, it should be understood that it is not intended to limit specific embodiments, and it should be understood to include all modifications, equivalents, and substitutes included in the spirit and scope of the present invention. Like reference numerals have been used for like components throughout the description of each drawing.

Terms such as first, second, A, B, and the like may be used to describe various components, but the components should not be limited by the terms. The terms are used only for the purpose of distinguishing one component from another. For example, a second component may be referred to as a first component, and similarly, the first component may also be referred to as the second component without departing from the scope of the present disclosure. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that still another component is not present therebetween.

The terms used in the present application are only used to describe specific embodiments and are not intended to limit the present invention. The singular includes the plural unless the context clearly dictates otherwise. It should be understood that the term such as “comprise,” “have,” or the like in this application does not preclude the possibility of the presence or addition of features, numbers, steps, operations, components, parts, or a combination thereof in advance.

Unless defined otherwise, all terms used herein, including technical or scientific terms, have the same meaning as commonly understood by those skilled in the art to which the present disclosure pertains.

Terms such as those defined in a commonly used dictionary should be construed as having a meaning consistent with the meaning in the context of the related art and should not be construed in an ideal or excessively formal meaning unless explicitly defined in the application.

In addition, each component, procedure, process, method, or the like included in each embodiment of the present disclosure can be shared within the range in which there is no contradiction in terms of technology.

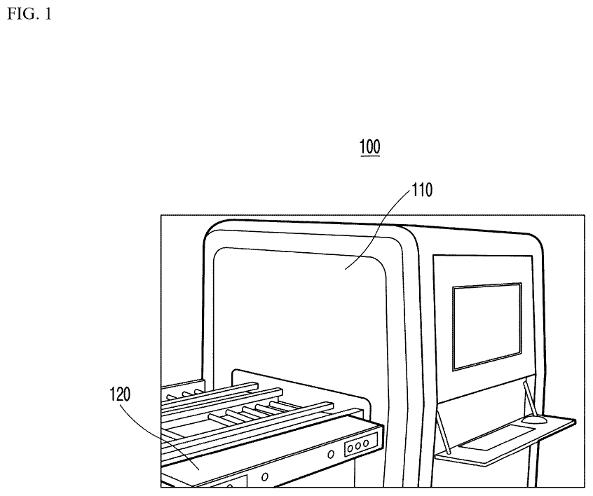

FIG. 1 is a diagram illustrating an example of an observation system according to an embodiment of the present invention.

Referring to FIG. 1, the observation system 100 according to an embodiment of the present invention includes an observation apparatus 110 and a stage 120.

The observation system 100 observes an observation target object moving on the stage 120 for various purposes, such as shape detection of the observation target object or determination of whether an abnormality has occurred on a surface thereof. The observation system 100 observes the observation target object by measuring optical characteristics of object light reflected from the observation target object (for example, a semiconductor, a display element, etc.). Here, the measured optical characteristics may include some or all of the phase, amplitude, and polarization components of the object light.

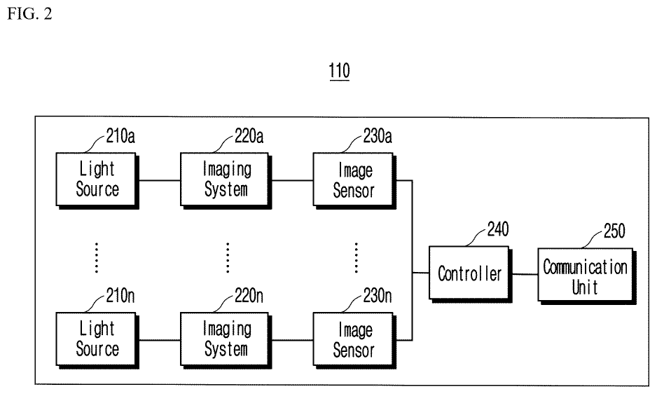

The observation apparatus 110 measures optical characteristics of the observation target object to observe the observation region and the observation target object. Despite including an imaging system operating as a magnifying optical system, the observation apparatus 110 can easily inspect an area wider than the observation region. In particular, as will be described later, the observation apparatus 110 can easily inspect an area wider than the observation region by observing the observation region in synchronization with a speed or a position of the observation target object on the stage 120. Accordingly, the inconvenience of having to observe while moving the observation region within the entire area of the observation target object, as in conventional observation apparatuses, can be eliminated. A more specific configuration of the observation apparatus 110 will be described later with reference to FIGS. 2 to 16.

The stage 120 places and moves the observation target object. The stage 120 moves the observation target object placed thereon toward the observation apparatus 110 at a predetermined speed. By moving the observation target object, the stage 120 enables the observation apparatus 110 to observe all portions of the observation target object even if the observation apparatus 110 is observing only one point. In some cases, the stage 120 transmits a movement position relative to a reference point to the observation apparatus 110, thereby enabling the observation apparatus 110 to determine how far the observation target object has moved from an initial position or a predetermined point, or to determine at which position the observation target object is currently located. The stage 120 may transmit the movement position at predetermined intervals, or may transmit its position at a time point when a reference point or the observation target object passes a designated point.

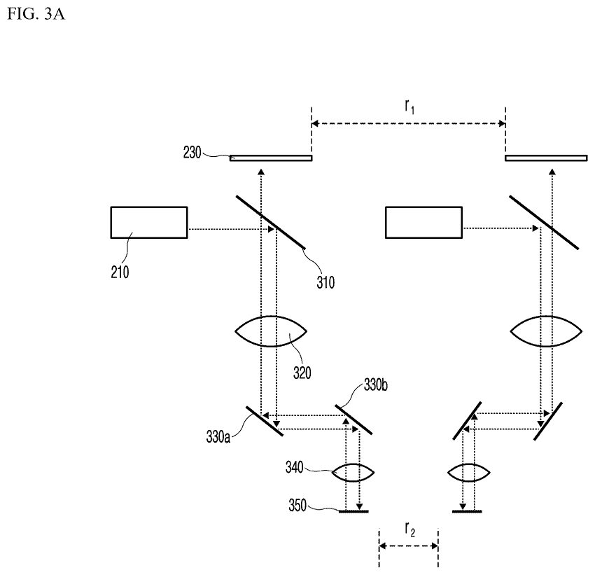

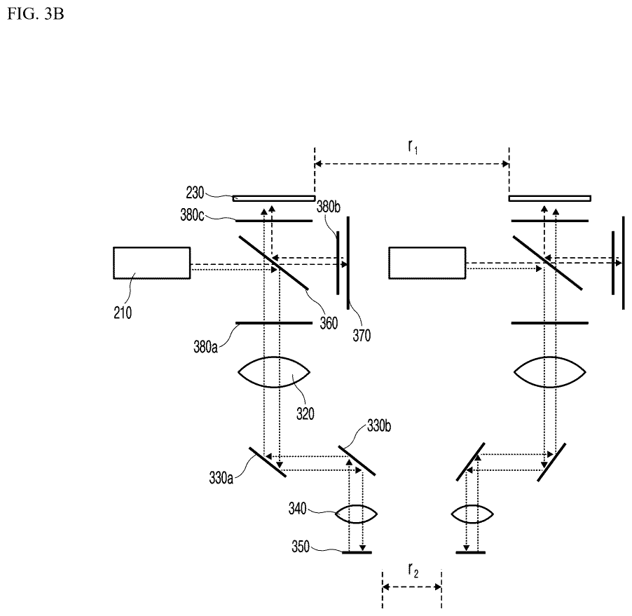

FIG. 2 is a diagram illustrating a configuration of the observation apparatus according to the first embodiment of the present invention, and FIG. 3A is a diagram illustrating an implementation example of the observation apparatus according to the first embodiment of the present invention.

Referring to FIGS. 2 and 3a, the observation apparatus 110 according to the first embodiment of the present invention includes one or more light sources 210a to 210n, a plurality of imaging systems 220a to 220n, a plurality of image sensors 230a to 230n, and a controller 240. Each imaging system 220 includes a beam splitter 310, a tube lens 320, a deflection element 330, and an objective lens 340. Furthermore, the observation apparatus 110 may further include a communication unit 250.

Each light source 210a to 210n irradiates light for observation of the observation region 350.

Each imaging system 220a to 220n directs light to the observation region 350, or directs light to the observation region 350 and a reference mirror 370, to generate object light or interference light including optical characteristics of the observation target object.

Each image sensor 230a to 230n receives object light or interference light generated by each imaging system 220a to 220n and senses optical characteristics of the observation target object. Each image sensor 230a to 230n receives the respective object light or interference light and senses optical characteristics of the object light, thereby enabling (an apparatus user, etc.) to observe the observation target object. Each image sensor 230a to 230n can perform sensing (On) or not perform sensing (Off). The image sensors 230a to 230n perform sensing at a specific time point under control of the controller 240, thereby sensing optical characteristics of the observation target object in synchronization with a speed or a position of the stage 120.

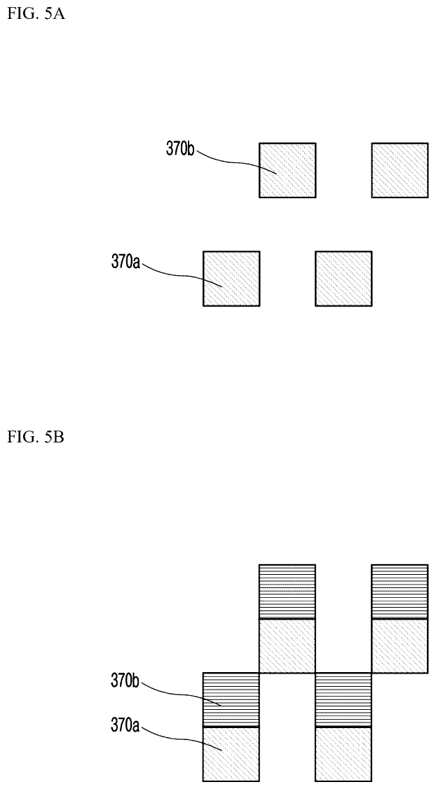

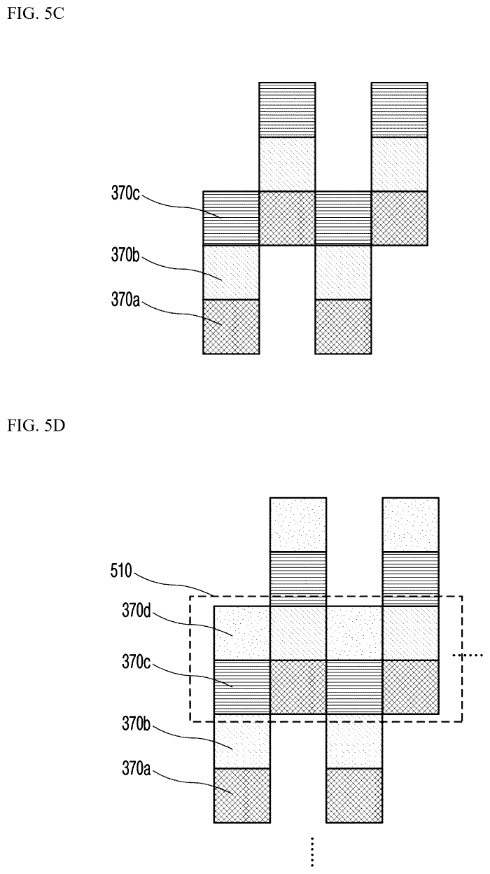

The controller 240 controls operation of each image sensor 230a to 230n and observes the observation target object based on sensing values of each image sensor 230a to 230n. As will be described later with reference to FIG. 5, the controller 240 controls operation of each image sensor 230a to 230n in synchronization with a speed of the stage 120 or a position of the observation target object. Although the controller 240 may also control operation of each light source 210a to 210n, the controller 240 may control operation of each image sensor 230a to 230n for convenience of control and operation. By controlling operation of each image sensor 230a to 230n to perform sensing at each time point when a predetermined time has elapsed (as will be described later with reference to FIG. 5), the controller 240 can observe an area equal to or greater than a predetermined reference value of the observation target object at once. Alternatively, when the communication unit 250 receives from the stage 120 that the stage 120 itself or the observation target object placed thereon is passing each predetermined position, the controller 240 may control each image sensor 230a to 230n to perform sensing at the corresponding time point. Accordingly, the controller 240 can observe an area equal to or greater than a predetermined reference value of the observation target object at once with only a degree of post-processing that combines sensing values sensed by each image sensor 230a to 230n over a certain period of time.

Furthermore, the observation apparatus 110 may further include the communication unit 250. The communication unit 250 receives a (movement) position of a reference point within the stage 120 or a position of the observation target object placed on the stage 120 from the stage 120, more specifically, from an encoder (not shown) within the stage 120. The communication unit 250 transmits the received information to the controller 240, thereby enabling the controller 240 to determine whether the observation target object is located at a point for sensing an image and to control the image sensor 230.

Each imaging system 220a to 220n may be implemented as a magnifying optical system (an optical system having a magnification greater than 1, in which the size of an image formed on an image sensor or the like is larger than the image of a target region), as illustrated in FIG. 3A, in order to observe the phase among optical characteristics of the observation target object.

The beam splitter 310 reflects light irradiated from the light source 210 toward the observation region 350 and transmits light reflected from the observation region 350 to the image sensor 230.

The tube lens 320 and/or the objective lens 340 enable light reflected by the beam splitter 310 and traveling toward the observation region 350 to be focused onto the observation region 350. Only the objective lens 340 may be included to perform the aforementioned operation, or both the tube lens 320 and the objective lens 340 may be included to perform the aforementioned operation.

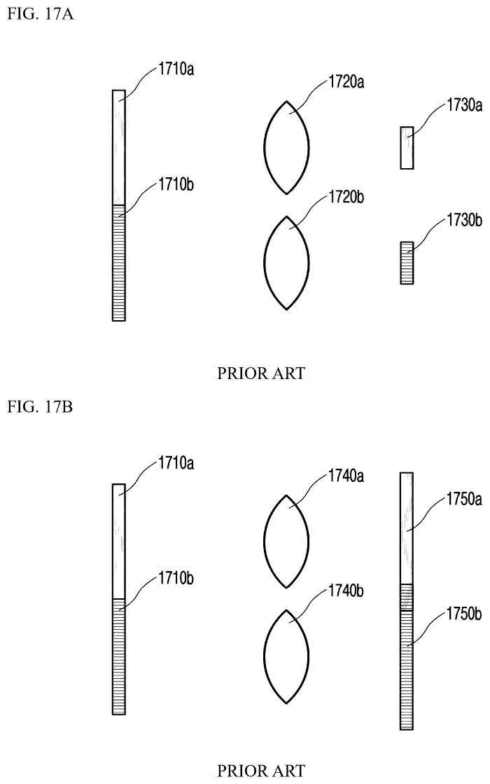

The deflection element 330 is disposed on an optical path on which light reflected by the beam splitter 310 travels toward the observation region 350, and converts the optical path. The deflection element 330 may be mainly disposed between the tube lens 320 and the objective lens 340, and may be implemented as any element capable of changing the path of light, such as a mirror, a diffraction grating, a prism, or a metasurface. The deflection element 330 converts the path of light reflected by the beam splitter 310 (to travel toward the observation region 350) in the direction of the observation region 350. As described above, the imaging system 220 operates as a magnifying optical system. The area of the image sensor 230 is implemented to be larger than the area of the observation region 350. If the observation region 350 and the image sensor 230 are disposed on the same axis, the same problem (in which image sensors 230 are physically overlappingly disposed) as that of the conventional magnifying optical system illustrated in FIG. 17B arises.

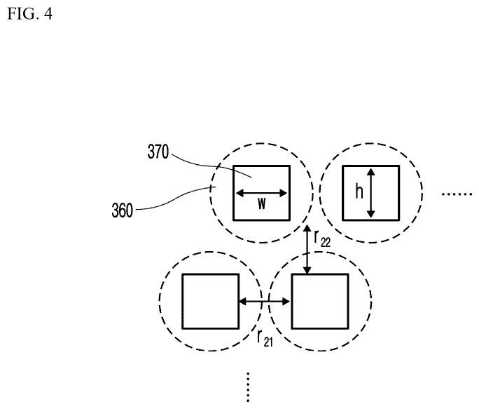

By disposing the deflection element 330 within each imaging system 220a to 220n, the observation regions 350 are formed to be spaced apart by only a predetermined distance (r2) in a width direction and a length direction, as will be described later with reference to FIG. 4, while adjacent image sensors 230a to 230n can be arranged so as not to physically overlap with each other (r1>0). Each light source 210a to 210n can simultaneously perform operation, and each image sensor 230a to 230n can receive interference light interfered in each imaging system 220a to 220n to sense optical characteristics of object light reflected from the observation target object. Accordingly, even if the imaging systems 220 implemented as magnifying optical systems are arranged in an array, the occurrence of problems as in the prior art can be eliminated.

Meanwhile, each imaging system 220a to 220n may be implemented as a magnifying optical system as illustrated in FIG. 3B in order to observe the amplitude or polarization component among optical characteristics of the observation target object.

FIG. 3B is a diagram illustrating another implementation example of the observation apparatus according to the first embodiment of the present invention.

Referring to FIGS. 2 and 3b, each imaging system 220 according to the first embodiment of the present invention includes a tube lens 320, a deflection element 330, an objective lens 340, a polarizing beam splitter 360, a reference mirror 370, and QWPs (Quarter Wave Plates) 380a to 380c.

The polarizing beam splitter 360 splits light irradiated from the light source 210 in different directions according to a polarization direction, or causes light reflected from the reference mirror 370 and the observation region 350 to interfere with each other and travel toward the image sensor 230.

The QWP 380a is disposed on an optical path of light traveling toward the observation region 350 among light split by the polarizing beam splitter 360, and converts linearly polarized light incident thereon to circularly polarized light, and converts circularly polarized light to linearly polarized light. Light split by the polarizing beam splitter 360 is converted to either left-circular polarization or right-circular polarization as it passes through the QWP 380a. Meanwhile, light reflected from the observation region 350 is converted back to linearly polarized light as it passes through the QWP 380a. At this time, since the light that has finally passed through the QWP 380a has passed through the QWP 380a twice, it has a polarization direction perpendicular to the direction of linear polarization when it was first incident on the QWP 380a.

The QWP 380b is disposed on an optical path of light traveling toward the reference mirror 370 among light split by the polarizing beam splitter 360, and performs the same operation as the QWP 380a. However, since the other one of the light split by the polarizing beam splitter 360 is incident on the QWP 380b, it has a polarization direction perpendicular to the polarization direction of the light passing through the QWP 380a.

The QWP 380c is disposed in front of the image sensor 230 on an optical path of light incident on the image sensor 230, and converts each linearly polarized light to circularly polarized light. As described above, since the light split by the polarizing beam splitter 360 passes through each QWP 380a and 380b twice, it has a linearly polarized state with a changed polarization direction. Accordingly, the QWP 380c converts each light to a circularly polarized state in front of the image sensor 230.

The tube lens 320 and/or the objective lens 340 focus light split by the polarizing beam splitter 360 and traveling toward the observation region 350 onto the observation region 350.

The deflection element 330 performs the aforementioned operation.

As each imaging system 220a to 220n has the structure illustrated in FIG. 3A or FIG. 3B, the observation apparatus 110 according to the first embodiment of the present invention proceeds with observation as illustrated in FIGS. 4 and 5.

FIG. 4 is a diagram illustrating observation regions of the observation apparatus according to the first embodiment of the present invention, and FIGS. 5A-5D are diagrams illustrating a process of observing an observation target object by the observation apparatus according to the first embodiment of the present invention. FIGS. 4 and 5A-5D are diagrams illustrating, from a top view direction, the process in which light irradiated from each light source 210 passes through each imaging system 220 to observe the observation region 350, and for convenience, four imaging systems forming four observation regions are illustrated as an example, but the present invention is not necessarily limited thereto.

Due to the characteristics of the magnifying optical system, the observation regions 350 formed by each imaging system 220 are implemented to be smaller than the size of the objective lens 340. At this time, as the respective deflection elements 330 are included within each imaging system 220, the observation regions 350 formed by each imaging system 220 are formed to be spaced apart by at least a predetermined distance (r21) in a width (w) direction and spaced apart by at least a predetermined distance (r22) in a length (h) direction. Here, the predetermined distance (r21) and the predetermined distance (r22) may each be formed as an integer multiple of the width (w) and the length (h) of the observation region 350. For example, the predetermined distance (r21) and the predetermined distance (r22) may be spaced apart by only the width (w) and the length (h) of the observation region 350, respectively, or may be spaced apart by n times (where n is 2 or more) the width (w) and the length (h) of the observation region 350, respectively.

At this time, the observation region most adjacently arranged on the length direction axis with respect to one observation region (for example, 370a in FIG. 5A) (for example, 370b in FIG. 5B) is arranged so as not to overlap with each other on the length direction axis.

As each imaging system 220a to 220n is implemented such that the observation regions are formed while satisfying the aforementioned conditions, observation of the observation target object can proceed as follows.

As illustrated in FIG. 5A, observation is performed at one time point. Accordingly, the image sensor 230 performs observation of the observation target object corresponding to each observation region 350.

Thereafter, as illustrated in FIGS. 5b to 5d, the controller 240 proceeds with observation in synchronization with the speed or position of the stage 120 (controls whether or not to operate the image sensor). The controller 240 analyzes speed or position information of the stage 120 to determine whether the stage 120 has moved by the width (w) or the length (h) of the observation region 350 according to the movement direction of the stage 120. When the stage 120 or the observation target object placed thereon has moved by the aforementioned amount, the controller 240 operates each image sensor 230 to additionally perform observation. In FIGS. 5A-5D, an example in which the stage 120 moves in the length (h) direction of the observation region 350 is illustrated. When observation proceeds in this manner, from a time point when an appropriate time has elapsed or an appropriate number of observations have been performed after observation has started, depending on the number of light sources 210, imaging systems 220, and image sensors 230, the observation target object can be observed in an expanded form 510 of the observation region 350, as illustrated in FIG. 5D. When the number of light sources 210 and imaging systems 220 increases so that the number of observation regions 350 increases in the width direction or the length direction, the observation apparatus 110 can observe a desired area at once from a time point when an appropriate time has elapsed.

Accordingly, even if the observation apparatus 110 includes imaging systems 220 implemented as magnifying optical systems, it can observe a desired area at once.

In the description provided above with reference to FIGS. 2 and 3, the light sources 210a to 210n are illustrated and described as being included in the observation apparatus 110 in a number equal to the number of imaging systems 220a to 220n to irradiate light to each imaging system 220a to 220n, but the present invention is not necessarily limited thereto. Light irradiated from the light source 210 may be split into a plurality of beams by an optical configuration such as a beam splitter, and accordingly, the observation apparatus 110 may include fewer light sources 210 than the number of imaging systems 220a to 220n, or may include only one light source.

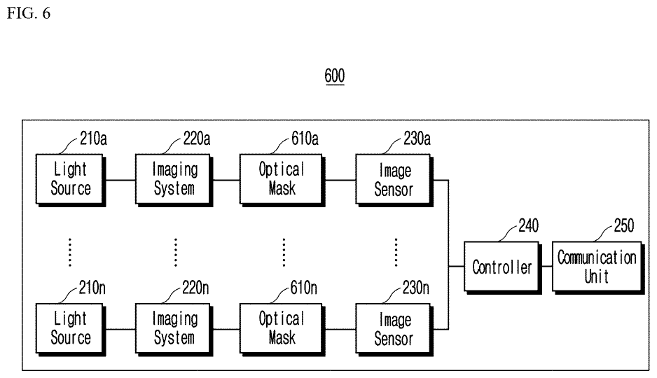

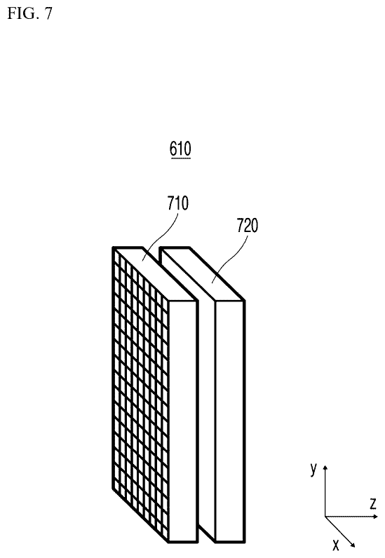

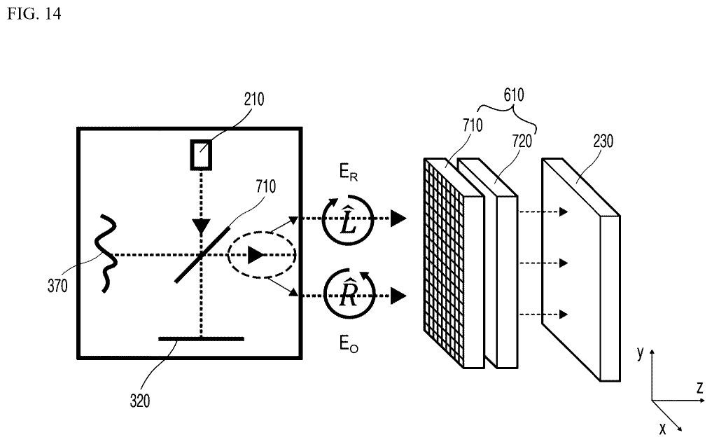

FIG. 6 is a diagram illustrating a configuration of an observation apparatus according to the second embodiment of the present invention, and FIG. 14 is a diagram illustrating an optical characteristic detection process of the observation apparatus according to the second embodiment of the present invention.

Referring to FIG. 6, the observation apparatus 600 according to the second embodiment of the present invention further includes a plurality of optical masks 610a to 610n in addition to the configuration of the observation apparatus 110 according to the first embodiment of the present invention.

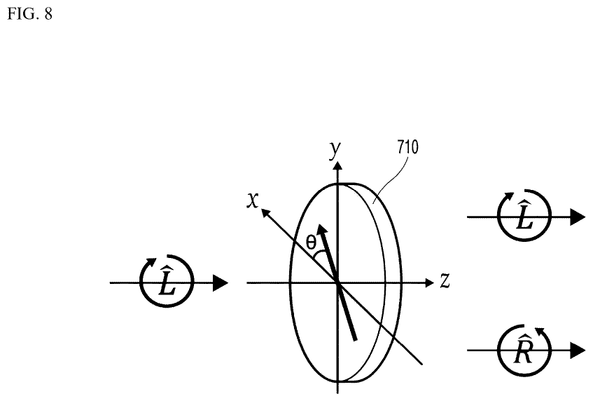

Each optical mask 610a to 610n receives interference light that has passed through each imaging system 220a to 220n in front of each image sensor 230a to 230n on an optical path, and generates a plurality of phase-shifted interference patterns. Taking FIG. 2 as an example, each optical mask 610a to 610n may be disposed between the QWP 380c and the image sensor 230 to perform the aforementioned operation. Each optical mask 610a to 610n can generate a plurality of phase-shifted interference patterns without including a plurality of captures or a plurality of image sensors as in the prior art, by using geometric phase optical elements. Specific structures and operations of each optical mask 610a to 610n are illustrated in FIGS. 7 to 13.

FIG. 7 is a diagram illustrating a configuration of the optical mask according to the second embodiment of the present invention.

Referring to FIG. 7, the optical mask 610 according to an embodiment of the present invention includes an optical array 710 and a circular polarization beam splitter 720.

The optical array 710 receives interference light interfered by the interferometer 220 and induces phase shifts, wherein it inherently induces phase shifts at a plurality of different angles with respect to the interference light.

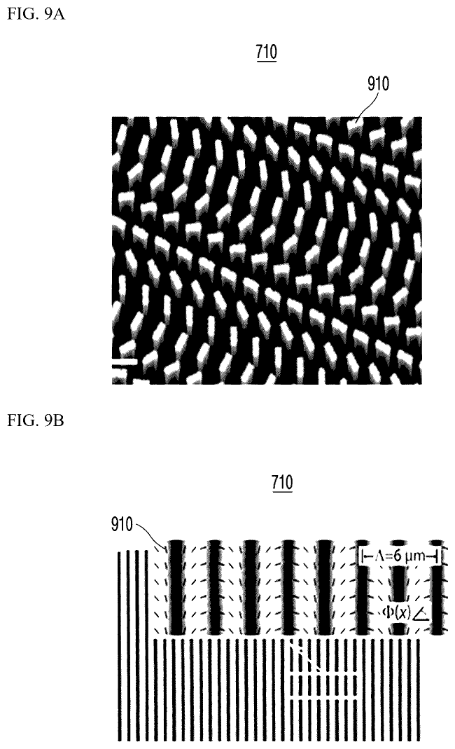

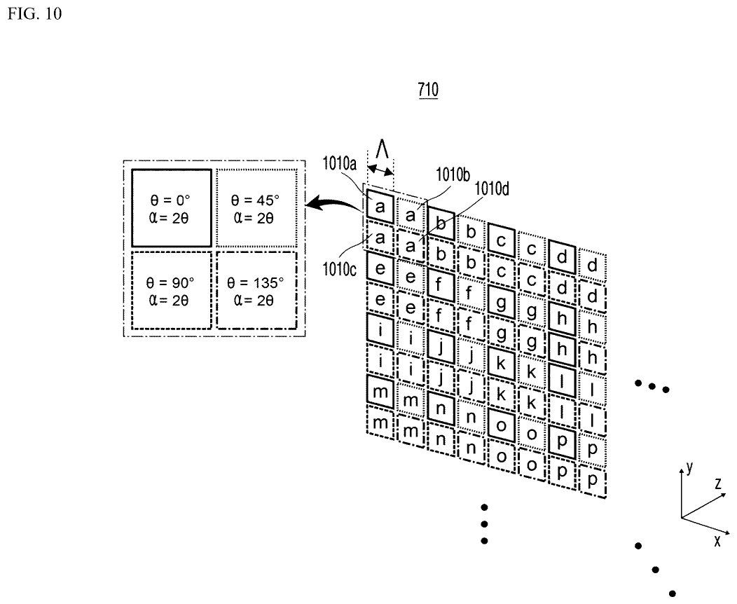

The optical array 710 is implemented as a geometric phase optical element as illustrated in FIGS. 8 and 9, thereby inducing phase shifts with respect to the incident interference light. FIG. 8 is a diagram explaining optical characteristics of the optical array according to the second embodiment of the present invention, FIGS. 9A-9D is a diagram illustrating material characteristics of a material constituting the optical array according to the second embodiment of the present invention, and FIG. 10 is a diagram illustrating a structure of the optical array according to the second embodiment of the present invention.

The optical array 710 is implemented as a geometric phase optical element. The optical array 710 may be implemented as a structure having a metasurface as illustrated in FIG. 9A, or implemented as a structure including liquid crystal as illustrated in FIG. 9B.

The optical array 710 may be implemented as a structure having a metasurface as illustrated in FIG. 9A. The anisotropic structure 910 having a metasurface is formed of a high refractive index material having a rectangular cross-section and a tall pillar shape, and may be arranged in a rotated form at each local position. A rectangular cross-section of the high refractive index material having a nano size smaller than the propagation wavelength exhibits optical anisotropy, and its rotational arrangement induces rotation of the optical axis. The anisotropic structures 910 having a metasurface may be manufactured by an E-beam lithography process or a semiconductor process for precisely fabricating nano-sized structures.

Alternatively, the optical array 710 may be implemented as a liquid crystal-based anisotropic structure 910 as illustrated in FIG. 9b. Since the liquid crystal-based anisotropic structure 910 itself exhibits characteristics of an anisotropic material, the structure 910 may be arranged in a rotated form like the arrangement of the liquid crystal alignment direction value Φ(x) at each local position to induce a geometric phase (Geometrical Phase) effect. When the optical array 710 is implemented as a liquid crystal-based anisotropic structure, it can be produced relatively inexpensively.

As such, the optical array 710 implemented as a geometric phase optical element has the optical characteristics illustrated in FIG. 8. The optical array 710 generates an additional geometric phase shift phenomenon due to the difference in the optical axis direction of the anisotropic material. Accordingly, when the optical array 710 is implemented as an anisotropic material having a phase retardance of T′, the following output light is produced when light having circularly polarized light in one direction is incident on the optical array 710.

$$\begin{matrix}T = R ( \text{?} ) \cdot ( \begin{matrix}1 & 0 \\ 0 & \text{?}\end{matrix} ) \cdot R ( \text{?} ) \\ = ( \begin{matrix}cos θ & sin θ \\ - sin θ & cos θ\end{matrix} ) ( \begin{matrix}1 & 0 \\ 0 & \text{?}\end{matrix} ) ( \begin{matrix}cos θ & - sin θ \\ sin θ & cos θ\end{matrix} )\end{matrix}$$

$${E}^{in} = \frac{1}{\sqrt{2}} ( \begin{matrix}1 \\ \pm i\end{matrix} ) = \hat{R} or \hat{L} , \hat{R} = \frac{1}{\sqrt{2}} ( \begin{matrix}1 \\ + i\end{matrix} ) , \hat{L} = \frac{1}{\sqrt{2}} ( \begin{matrix}1 \\ - i\end{matrix} )$$

$$\begin{matrix}{E}^{GP} = T \cdot {E}^{in} \\ = cos ( \frac{Γ}{2} ) \frac{1}{\sqrt{2}} ( \begin{matrix}1 \\ \pm i\end{matrix} ) - i sin ( \frac{Γ}{2} ) {e}^{i ( \pm 2 θ )} \frac{1}{\sqrt{2}} ( \begin{matrix}1 \\ ∓ i\end{matrix} ) \\ = cos ( \frac{Γ}{2} ) \frac{1}{\sqrt{2}} ( \begin{matrix}1 \\ \pm i\end{matrix} ) + sin ( \frac{Γ}{2} ) {e}^{i ( \pm 2 θ - \frac{π}{2} )} \frac{1}{\sqrt{2}} ( \begin{matrix}1 \\ ∓ i\end{matrix} )\end{matrix}$$

$$Γ = \frac{2 π}{λ} ( {n}_{e} - {n}_{o} ) t$$

$$\text{?} \text{indicates text missing or illegible when filed}$$

Here, T denotes a Jones Matrix, E\hat{ }in denotes incident light entering the optical array 710, E\hat{ }GP denotes output light emitted from the optical array 710, R-hat denotes right-circular polarization, L-hat denotes left-circular polarization, θ denotes the optical axis rotation angle of the anisotropic material, ne denotes the refractive index of the fast axis of the anisotropic material, no denotes the refractive index of the slow axis of the anisotropic material, and t denotes the thickness of the anisotropic material in the light propagation direction, respectively.

According to the aforementioned equations, when light of one polarization is incident on the optical array 710, a polarization component identical to the incident light (the component including the cos term in the equation related to the output light) and an opposite polarization component whose phase has been shifted (delayed) by twice the optical axis rotation angle of the anisotropic material (the component including the sin term in the equation related to the output light) are respectively emitted.

Meanwhile, the optical array 710 having such characteristics includes a plurality of optical pixels 1010 implemented in an array form using anisotropic material that induces a geometric phase (Geometrical Phase) effect, as illustrated in FIG. 10.

At this time, unlike the conventional case in which each pixel receives interference light from different points (of the observation target object), a plurality of (at least three or more) adjacent optical pixels 1010a to 1010d receive interference light from the same point (of the observation target object). However, the optical pixels 1010 that receive interference light from the same point are likewise implemented as anisotropic materials having the aforementioned properties, but have different optical axis rotation angles from each other. For example, as illustrated in FIG. 10, assuming that four optical pixels 1010a to 1010d adjacent in the horizontal (x-axis direction) and vertical (y-axis) directions receive interference light from the same point, each optical pixel 1010a to 1010d may have optical axis rotation angles of 0°, 45°, 90°, and 135°.

Accordingly, phase shifts of 0°, 90°, 180°, and 270°, which are twice the optical axis rotation angles, occur in the polarization component whose phase is shifted (delayed) among the incident light passing through each optical pixel 1010a to 1010d.

As such, when the number of optical pixels 1010a to 1010d receiving interference light from the same point within the optical array 710 is denoted as n, and the pixel size of the image sensor 230 is denoted as Λ, the optical pixels 1010a to 1010d within the optical array 710 may be repeatedly arranged with a period of nΛ. In FIG. 10, since the optical pixels 1010a to 1010d are arranged adjacent to each other in the horizontal and vertical directions, they may be repeatedly arranged with a period of 2Λ in the horizontal and vertical directions within the optical array 710. The optical array 710 having such an optical pixel 1010 arrangement can acquire all phase-shifted interference patterns for analysis of optical characteristics of the observation target object even by receiving interference light only once. Accordingly, the optical array 710 can fundamentally block the influence of disturbances such as vibration in the process of acquiring all interference patterns having different phase shift angles as in the prior art, and there is no need to provide a plurality of image sensors. Since only an optical mask 610 having a very thin thickness needs to be disposed in front of one image sensor 230, it can have a simple structure, and the overall volume of the optical mask 610 or the observation apparatus 600 including the same can be considerably reduced.

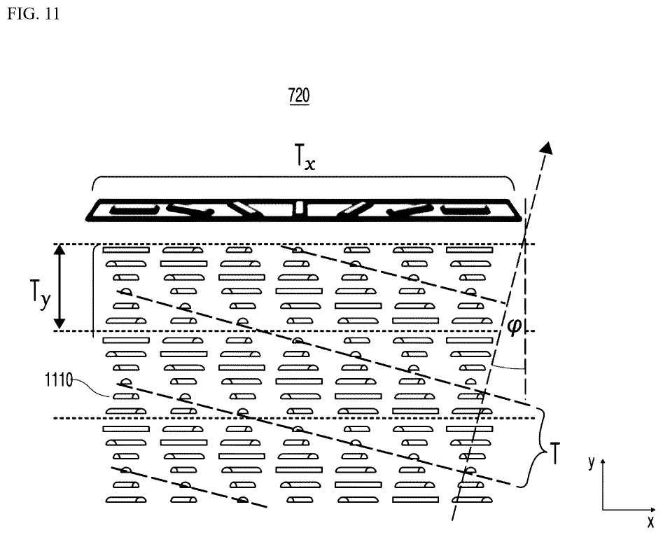

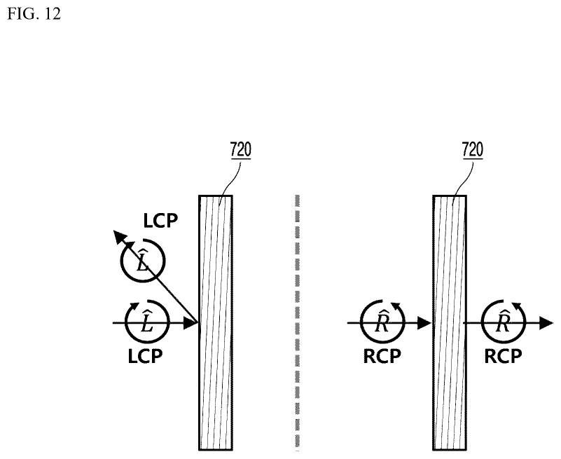

Referring again to FIG. 7, light of each polarization component emitted from the optical array 710 is incident on the circular polarization beam splitter 720. Since the circular polarization beam splitter 720 has the characteristics illustrated in FIG. 11, it can operate as illustrated in FIG. 12.

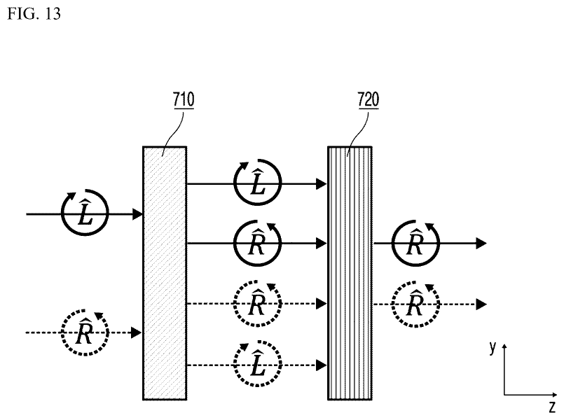

FIG. 11 is a diagram illustrating a structure and chiral volume grating characteristics of the circular polarization beam splitter according to the second embodiment of the present invention, FIG. 12 is a diagram explaining optical characteristics of the circular polarization beam splitter according to the second embodiment of the present invention, and FIG. 13 is a diagram explaining optical characteristics of the optical mask according to the second embodiment of the present invention.

Referring to FIG. 11, the circular polarization beam splitter 720 has a helical structural property, that is, chirality. An element in which the molecular directions of the anisotropic structures 1110 are sequentially rotated and aligned along the vertical axis (y-axis) direction is called a chiral element. For example, when a chiral dopant is added to a nematic liquid crystal in which liquid crystal molecules are all oriented in a uniform direction, the chiral dopant can induce chiral alignment of the nematic liquid crystal. At this time, the period Ty of the chiral property can be determined by the concentration of the chiral dopant.

Furthermore, when the liquid crystal boundary surface is aligned to have an alignment period Tx using various methods, the chiral liquid crystal alignment layer can be fabricated as a volume grating. In general, the propagation of light in a volume grating satisfies a Bragg diffraction condition between the propagation constants of incident light and output light and the grating vector, which follows the Floquet theorem.

By having such conditions, the circular polarization beam splitter 720 operates as illustrated in FIG. 12. The circular polarization beam splitter 720 reflects a circular polarization component having the same rotational direction as the helical structure thereof among light incident thereon, and transmits a circular polarization component rotating in the opposite direction thereof. More specifically, since the volume grating characteristic selectively appears in the circular polarization beam splitter 720 depending on the circular polarization direction of the incident light, the circular polarization beam splitter 720 can selectively perform the function of a mirror or a beam splitter depending on the polarization direction of the incident light. For example, when the circular polarization beam splitter 720 has left helicity as illustrated in FIG. 12, it can reflect the left-circular polarization component among light incident thereon and transmit only the right-circular polarization component.

The optical mask 610 includes the optical array 710 and the circular polarization beam splitter 720 having the aforementioned characteristics, and thus operates as illustrated in FIG. 13.

As described above, when object light polarized in one direction (for example, left-circular polarization) and reference light polarized in another direction (for example, right-circular polarization) are respectively incident on the optical array 710, each light passes through the optical array 710 and is respectively emitted as a polarization component identical to the incident light without phase shift and an opposite polarization component with phase shift.

The circular polarization beam splitter 720 receives light emitted from the optical array 710 and reflects only one polarization component (for example, left-circular polarization) among the incident polarization components, and transmits the other polarization component. Among the transmitted polarization components, one is light whose phase has not been shifted, and the other corresponds to light whose phase has been shifted by twice the optical axis rotation angle. The components that pass through the circular polarization beam splitter 720 interfere with each other to form interference patterns and travel toward the image sensor 230.

For example, if the thickness (T) of the optical array 710 is adjusted to π/2, the following interference patterns are formed in the interference light that has passed through the optical mask 610.

$${E}_{o}^{in} = \hat{L} {A}_{o} {e}^{i {ϕ}_{o}}$$

$${E}_{R}^{in} = \hat{R} {A}_{R} {e}^{i {ϕ}_{R}}$$

$${E}_{o}^{GP} = \frac{1}{\sqrt{2}} \hat{L} {A}_{o} {e}^{i {ϕ}_{o}} + \frac{1}{\sqrt{2}} \hat{R} {A}_{o} {e}^{i ( {ϕ}_{o} - 2 θ - \frac{π}{2} )}$$

$${E}_{R}^{GP} = \frac{1}{\sqrt{2}} \hat{R} {A}_{R} {e}^{i {ϕ}_{R}} + \frac{1}{\sqrt{2}} \hat{L} {A}_{R} {e}^{i ( {ϕ}_{R} + 2 θ - \frac{π}{2} )}$$

$$\begin{matrix}I ( θ ) = {\vert {E}_{o}^{CM} + {E}_{R}^{CM} \vert}^{2} \\ = {\vert \frac{1}{\sqrt{2}} \hat{R} {A}_{o} {e}^{i ( {ϕ}_{o} - 2 θ - \frac{π}{2} )} + \frac{1}{\sqrt{2}} \hat{R} {A}_{R} {e}^{i {ϕ}_{R}} \vert}^{2} \\ = \frac{1}{2} [ {A}_{o}^{2} + {A}_{R}^{2} + 2 {A}_{o} {A}_{R} cos ( {ϕ}_{R} - {ϕ}_{o} + 2 θ + \frac{π}{2} ) ]\end{matrix}$$

Here,

$${E}_{o}^{in}$$

denotes the object light component among the incident light,

$${E}_{R}^{in}$$

denotes the reference light component among the incident light,

$${E}_{o}^{GP}$$

denotes the object light component that has passed through the optical array 710,

$${E}_{R}^{GP}$$

denotes the reference light component that has passed through the optical array 710,

$${E}_{o}^{CM}$$

denotes the object light component that has passed through the circular polarization beam splitter 720,

$${E}_{R}^{CM}$$

denotes the reference light component that has passed through the circular polarization beam splitter 720, and I(θ) denotes the interference pattern image with respect to the optical axis rotation angle θ, respectively.

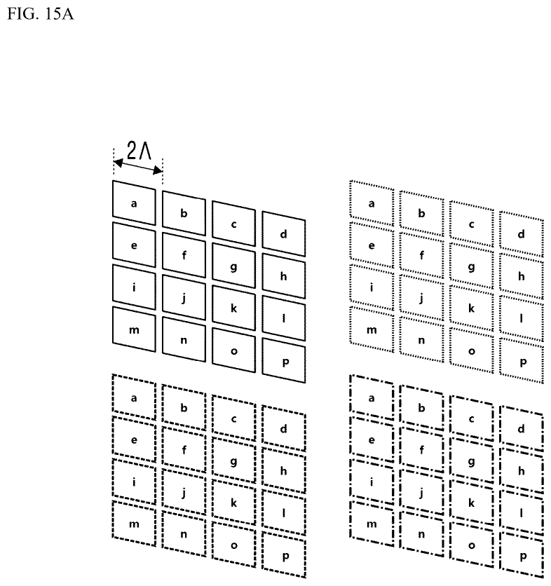

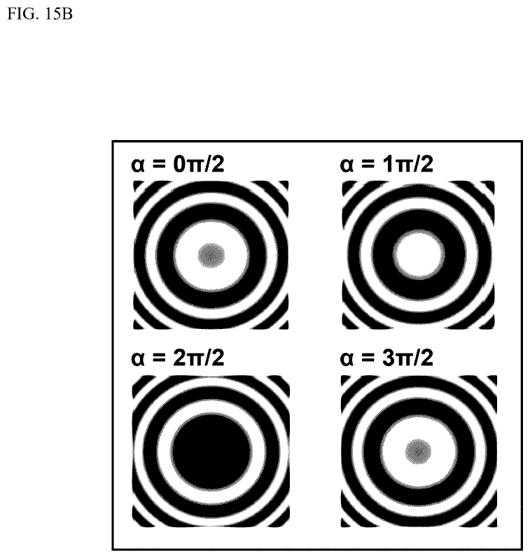

Referring again to FIG. 6, the image sensor 230 receives a plurality of phase-shifted interference patterns that have passed through the optical mask 610, and measures optical characteristics of object light reflected from the observation target object based on the received interference patterns. As illustrated in FIGS. 15A and 15B, the image sensor 230 can acquire (a plurality of) phase-shifted interference pattern images that are phase-shifted by the same angle according to the optical axis rotation angle.

FIGS. 15A and 15B are diagrams illustrating a pixel structure of phase-shifted interference patterns detected by the detection unit according to the second embodiment of the present invention.

Referring to FIGS. 15A and 15B, the image sensor 230 can group a plurality of interference patterns that are phase-shifted by the same angle according to the optical axis rotation angle, thereby acquiring a plurality of phase-shifted interference patterns. The image sensor 230 can detect optical characteristics (phase, amplitude, polarization) of the object light from the acquired plurality of phase-shifted interference patterns.

Since the image sensor 230 can receive at least three or more interference patterns shifted at different angles from the optical mask 610, it can detect the amplitude of the object light, the amplitude of the reference light, and the phase of the object light relative to the reference light, respectively, as follows.

$$ϕ = {tan}^{- 1} [ \frac{I ( \frac{π}{2} ) - I ( \frac{3 π}{2} )}{I ( \frac{0 \cdot π}{2} ) - I ( \frac{2 π}{2} )} ]$$

$${A}_{R}^{2} or {A}_{o}^{2} = \frac{1}{2} [ S \pm \sqrt{{S}^{2} - ( {D}_{13}^{2} + {D}_{02}^{2} )} ]$$

$$S ≡ I ( \frac{O \cdot π}{2} ) + I ( \frac{2 π}{2} ) = {A}_{R}^{2} + {A}_{o}^{2}$$

$${D}_{02} ≡ I ( \frac{0 \cdot π}{2} ) - I ( \frac{2 π}{2} ) = 2 {A}_{R} {A}_{o} cos ϕ$$

$${D}_{13 ≡ I (} \frac{1 \cdot π}{2} ) + I ( \frac{3 π}{2} ) = 2 {A}_{R} {A}_{o} sin ϕ$$

Here, A_{R} denotes the amplitude of the reference light, Ao denotes the amplitude of the object light, and S denotes the Stokes parameter, respectively.

Through the aforementioned process, the image sensor 230 can detect the phase and amplitude of the object light.

Furthermore, the image sensor 230 can detect the polarization state of the object light using the plurality of received interference patterns. The image sensor 230 can detect Stokes parameters (Stokes' parameter, {S₀, S₁, S₂, S₃}), which represent the polarization of light, from the amplitude of left-circular polarization, the phase of left-circular polarization, the amplitude of right-circular polarization, and the phase of right-circular polarization. The image sensor 230 can detect the Stokes parameters according to the following equations.

$$E = \hat{R} {A}_{r} {e}^{i {ϕ}_{γ}} + \hat{L} {A}_{l} {e}^{i {ϕ}_{l}} = \hat{x} {A}_{x} {e}^{i {ϕ}_{x}} + \hat{y} {A}_{y} {e}^{i {ϕ}_{y}}$$

$${A}_{x} {e}^{i {ϕ}_{x}} = \frac{1}{\sqrt{2}} [ {A}_{r} cos {ϕ}_{r} + {A}_{l} cos {ϕ}_{l} ] + i \frac{1}{\sqrt{2}} [ {A}_{r} sin {ϕ}_{r} + {A}_{l} sin {ϕ}_{l} ] = {a}_{x} + {ib}_{x}$$

$${A}_{x} = \sqrt{{a}_{x}^{2} + {b}_{x}^{2}} , {ϕ}_{x =} {tan}^{- 1} ( \frac{{b}_{x}}{{a}_{x}} )$$

$${A}_{y} {e}^{i {ϕ}_{y}} = \frac{1}{\sqrt{2}} [ - {A}_{r} sin {ϕ}_{r} + {A}_{l} sin {ϕ}_{l} ] + i \frac{1}{\sqrt{2}} [ {A}_{r} cos {ϕ}_{r} - {A}_{l} cos {ϕ}_{l} ] = {a}_{y} + {ib}_{y}$$

$${A}_{y} = \sqrt{{a}_{y}^{2} + {b}_{y}^{2}} , {ϕ}_{y =} {tan}^{- 1} ( \frac{{b}_{y}}{{a}_{y}} )$$

Here, Aᵣ denotes the amplitude of right-circular polarization, φᵣ denotes the phase of right-circular polarization, Aₗ denotes the amplitude of left-circular polarization, and φₗ denotes the phase of left-circular polarization, respectively.

At this time, each Stokes parameter is calculated as follows.

$${S}_{0} = {A}_{x}^{2} + {A}_{y}^{2} ,$$

$${S}_{1} = {A}_{x}^{2} - {A}_{y}^{2} ,$$

$${S}_{2} = 2 {A}_{x} {A}_{y} cos ( {ϕ}_{y} - {ϕ}_{x} ) ,$$

$${S}_{3} = 2 {A}_{x} {A}_{y} sin ( {ϕ}_{y} - {ϕ}_{x} )$$

The image sensor 230 can detect the polarization state from the amplitude and phase of the object light through the aforementioned process.

Accordingly, even if the observation apparatus 600 receives interference light from the observation target object only once, the image sensor 230 can detect the optical characteristics of the object light. Accordingly, the image sensor 230 can detect the three-dimensional shape (of the observation target object) having a pixel size of Λ.

In the description provided above with reference to FIG. 6 and the like, the light sources 210a to 210n are illustrated and described as being included in the observation apparatus 600 in a number equal to the number of imaging systems 220a to 220n to irradiate light to each imaging system 220a to 220n, but the present invention is not necessarily limited thereto. Light irradiated from the light source 210 may be split into a plurality of beams by an optical configuration such as a beam splitter, and accordingly, the observation apparatus 600 may include fewer light sources 210 than the number of imaging systems 220a to 220n, or may include only one light source.

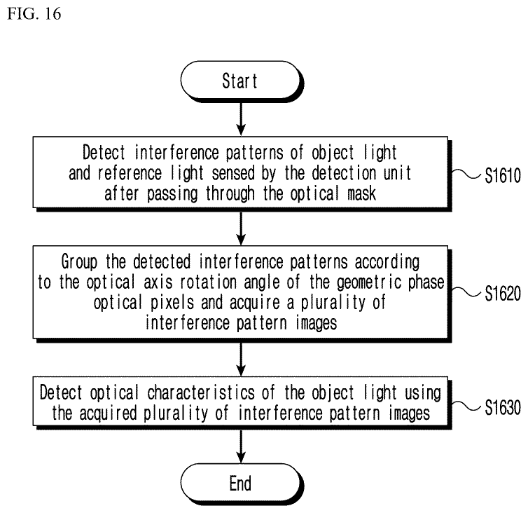

FIG. 16 is a flowchart illustrating a method for the observation apparatus to detect optical characteristics of an observation target object according to the second embodiment of the present invention.

The image sensor 230 detects interference patterns of object light and reference light that have passed through the optical mask 610 (S1610). The image sensor 230 detects interference patterns formed by the object light polarized in one direction and the reference light polarized in the same direction as the object light that have passed through the optical mask 610.

The image sensor 230 groups the detected interference patterns according to the optical axis rotation angle of the geometric phase optical pixels and acquires a plurality of interference pattern images (S1620).

The image sensor 230 detects optical characteristics of the object light using the acquired plurality of interference pattern images (S1630).

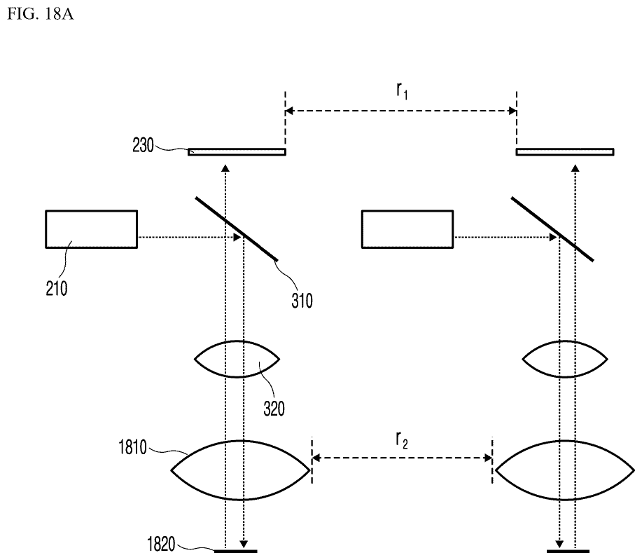

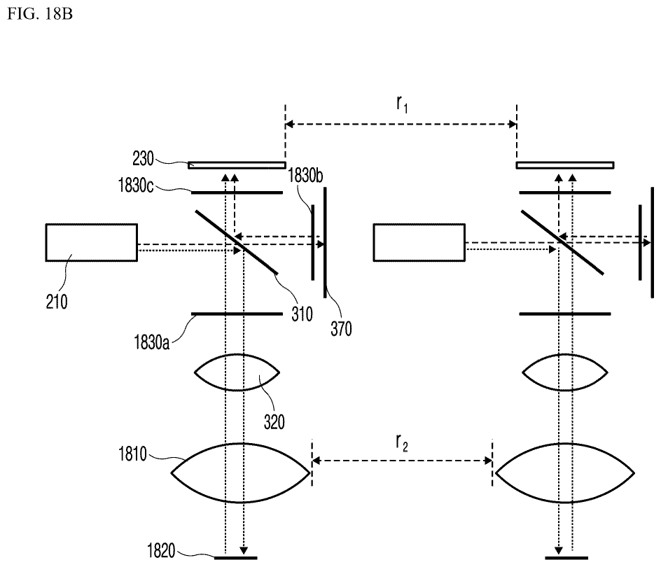

FIGS. 18A and 18B are diagrams illustrating an implementation example of an observation apparatus according to the third embodiment of the present invention.

Referring to FIG. 18A, the observation apparatus according to the third embodiment of the present invention is also implemented in the same manner as the observation apparatus 110 according to the first embodiment of the present invention, but may have imaging systems 220a to 220n of a different form. Each imaging system 220 includes a beam splitter 310, a tube lens 320, and an objective lens 1810.

The beam splitter 310 reflects light irradiated from the light source 210 toward the observation region 1820 and transmits light reflected from the observation region 1820 to the image sensor 230.

The tube lens 320 and/or the objective lens 1810 focus light reflected by the beam splitter 310 and traveling toward the observation region 1820 onto the observation region 1820. Only the objective lens 1810 may be included to perform the aforementioned operation, or both the tube lens 320 and the objective lens 1810 may be included to perform the aforementioned operation.

The objective lens 1810 has a (cross-sectional) area or diameter that is significantly larger relative to the area of the observation region 1820, and also has an area or diameter that is larger than that of the image sensor 230. It has a (cross-sectional) area or diameter that is several to several tens of times larger than the area of the observation region 1820. Accordingly, the objective lens 1810 can focus light reflected by the beam splitter 310 or light that has passed through the tube lens 320 onto the observation region 1820, and directs light reflected from the observation region 1820 to travel back toward the tube lens 320 or the beam splitter 310.

At this time, the centers of the image sensor 230, the objective lens 1810 (including the tube lens), and the observation region 1820 are disposed on the same line or disposed at positions within a predetermined error range therefrom. Since the (cross-sectional) area or diameter of the objective lens 1810 is implemented to be larger than the size or diameter of the image sensor 230 or the observation region 1820, when each optical component (230, 1810, 1820) is disposed as described above, the spacing (r2) between adjacent objective lenses 1810 is smaller than the spacing (r1) between adjacent image sensors 230 or the spacing between observation regions 1820. Therefore, even if the imaging systems 220 are implemented as magnifying optical systems, the respective optical components within the imaging system can be arranged and operated without difficulty.

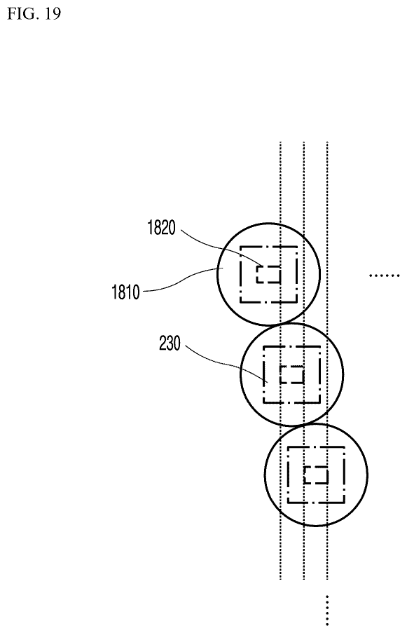

In particular, the observation regions 1820 are arranged in parallel (without gaps) in a direction perpendicular to the movement direction of the stage 120 (on the same plane), as will be described later with reference to FIG. 19. Each light source 210a to 210n can simultaneously perform operation, and each image sensor 230a to 230n can receive interference light interfered in each imaging system 220a to 220n to sense optical characteristics of object light reflected from the observation target object. Accordingly, even if the imaging systems 220 implemented as magnifying optical systems are arranged in an array, the occurrence of problems as in the prior art can be eliminated.

Meanwhile, each imaging system 220a to 220n may be implemented as a magnifying optical system (an optical system having a magnification greater than 1, in which the size of an image formed on an image sensor or the like is larger than the image of a target region) as illustrated in FIG. 17B, in order to observe the amplitude or polarization component among optical characteristics of the observation target object.

FIG. 18B is a diagram illustrating another implementation example of the observation apparatus according to the third embodiment of the present invention.

Referring to FIGS. 2 and 18B, each imaging system 220 according to the third embodiment of the present invention includes a tube lens 320, an objective lens 1810, a polarizing beam splitter 1830, a reference mirror 370, and QWPs (Quarter Wave Plates) 1840a to 1840c.

The polarizing beam splitter 1830 splits light irradiated from the light source 210 in different directions according to a polarization direction, or causes light reflected from the reference mirror 370 and the observation region 1820 to interfere with each other and travel toward the image sensor 230.

The QWP 1840a is disposed on an optical path of light traveling toward the observation region 1820 among light split by the polarizing beam splitter 1830, and converts linearly polarized light incident thereon to circularly polarized light, and converts circularly polarized light to linearly polarized light. Light split by the polarizing beam splitter 1830 is converted to either left-circular polarization or right-circular polarization as it passes through the QWP 1840a. Meanwhile, light reflected from the observation region 1820 is converted back to linearly polarized light as it passes through the QWP 1840a. At this time, since the light that has finally passed through the QWP 1840a has passed through the QWP 1840a twice, it has a polarization direction perpendicular to the direction of linear polarization when it was first incident on the QWP 1840a.

The QWP 1840b is disposed on an optical path of light traveling toward the reference mirror 370 among light split by the polarizing beam splitter 1830, and performs the same operation. However, since the other one of the light split by the polarizing beam splitter 1830 is incident on the QWP 1840b, it has a polarization direction perpendicular to the polarization direction of the light passing through the QWP 1840a.

The QWP 1840c is disposed in front of the image sensor 230 on an optical path of light incident on the image sensor 230, and converts each linearly polarized light to circularly polarized light. As described above, since the light split by the polarizing beam splitter 1830 passes through each QWP 1840a and 1840b twice, it has a linearly polarized state with a changed polarization direction. Accordingly, the QWP 1840c converts each light to a circularly polarized state in front of the image sensor 230.

The tube lens 320 and/or the objective lens 1810 focus light split by the polarizing beam splitter 1830 and traveling toward the observation region 1820 onto the observation region 1820, or direct light reflected from the observation region 1820 to travel back toward the tube lens 320 or the polarizing beam splitter 1830.

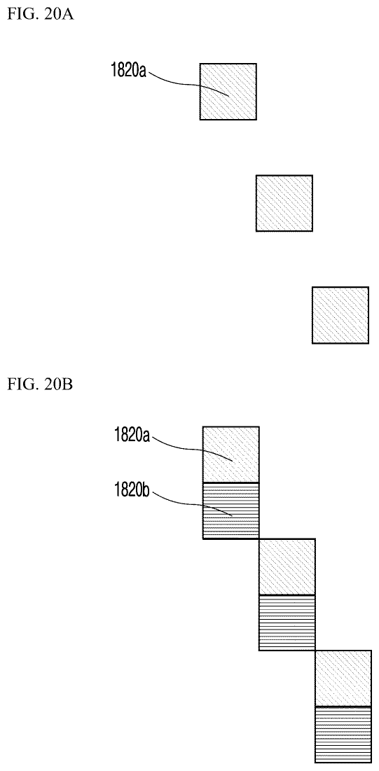

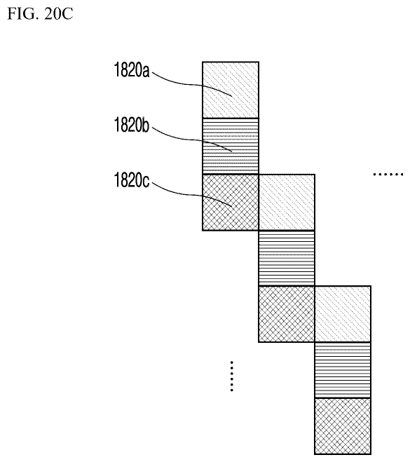

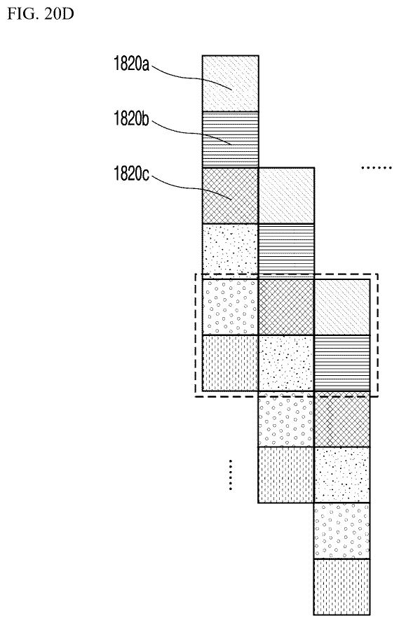

As each imaging system 220a to 220n has the structure illustrated in FIG. 18A or FIG. 18B, the observation apparatus according to the third embodiment of the present invention proceeds with observation as illustrated in FIGS. 19 and 20A-20D.

FIG. 19 is a diagram illustrating observation regions of the observation apparatus according to the third embodiment of the present invention, and FIGS. 20A-20D are diagrams illustrating a process of observing an observation target object by the observation apparatus according to the third embodiment of the present invention. FIGS. 19 and 20A-20D are diagrams illustrating, from a top view direction, the process in which light irradiated from each light source 210 passes through each imaging system 220 to observe the observation region 1820, and for convenience, three imaging systems forming three observation regions are illustrated as an example, but the present invention is not necessarily limited thereto.

As described above, within one imaging system 220, the centers of the image sensor 230, the objective lens 1810, and the observation region 1820 coincide or are disposed at similar positions, and the (cross-sectional) area or diameter of the objective lens 1810 is implemented to be larger than that of the image sensor 230 or the observation region 1820. At this time, the objective lenses 1810 are arranged in parallel with adjacent objective lenses, and the observation regions 1820 within each imaging system are arranged without gaps (in parallel) in a direction perpendicular to the movement direction of the stage 120 (on the same plane). As illustrated in FIG. 19, the objective lenses 1810a to 1810c are arranged without physical gaps (in parallel), and it can be confirmed that the observation regions 1820 are arranged without gaps in a direction perpendicular to the movement direction of the stage 120.

Accordingly, the observation apparatus 110 can observe some or all of the observation region in a direction perpendicular to the movement direction of the stage 120 depending on the number of imaging systems 220, and the observation regions are formed to be spaced apart by a predetermined distance from each other in the movement direction of the stage 120. In particular, the predetermined distance may be an integer multiple of the length of the observation region 1820 (in the movement direction of the stage 120). Accordingly, between adjacent observation regions 1820, there is a structure in which n observation regions can be arranged in the movement direction of the stage 120.

As each imaging system 220a to 220n is implemented such that the observation regions are formed while satisfying the aforementioned conditions, observation of the observation target object can proceed as described above with reference to FIGS. 5A-5D.

Although each process is described as being executed sequentially in FIGS. 16, this is merely an example of the technical idea of one embodiment of the present disclosure. That is, since those skilled in the art to which one embodiment of the present disclosure pertains can modify and change the present embodiment in various ways and apply the modifications and changes by changing the order described in each drawing to perform the processes or executing one or more of processes in parallel without departing from the essential characteristics of one embodiment of the present disclosure, FIG. 16 are not limited to the time-series order.

Meanwhile, the processes illustrated in FIG. 16 may be implemented as computer-readable codes on a computer-readable recording medium. The computer-readable recording medium includes any type of recording device in which data that may be read by a computer system are stored. That is, the computer-readable recording medium may include a storage medium such as a magnetic storage medium (e.g., a read only memory (ROM), a floppy disk, a hard disk, or the like) and an optical reading medium (e.g., a CD-ROM, a DVD, or the like). In addition, the computer-readable recording medium may be distributed to a computer system connected via a network so that computer-readable code may be stored and executed in a distributed manner.

The above description is merely the exemplary description of the technical spirit of the present embodiment, and those skilled in the art to which the present embodiment pertains will be able to modify and change the present embodiment in various ways without departing from the essential characteristics of the present embodiment. Accordingly, the present embodiments are not intended to limit the technical spirit of the present embodiment, but are intended to describe the same, and the scope of the technical spirit of the present embodiment is not limited by these embodiments. The scope of the present embodiment should be construed by the appended claims, and all technical ideas within the equivalent scope should be construed as being included in the scope of the present embodiment.

What is claimed is:

1. An observation apparatus for observing an observation target object, comprising:
one or more light sources for irradiating light for observation of an observation region;
a plurality of imaging systems, each configured to direct light to the observation region or to the observation region and to a reference mirror provided in the imaging system, to generate object light or interference light including optical characteristics of the observation target object;
a plurality of image sensors for receiving light generated by each imaging system and sensing optical characteristics of the observation target object; and
a controller for controlling operation of each image sensor and observing the observation target object based on sensing values of each image sensor,
wherein each imaging system is implemented such that a size of an image formed on the image sensor is larger than an image of the observation region.

2. The observation apparatus of claim 1, wherein each imaging system includes a deflection element for converting an optical path.

3. The observation apparatus of claim 2, wherein the image sensors are arranged so as not to physically overlap with each other.

4. The observation apparatus of claim 3, wherein the deflection element converts the path of light such that the image sensors are arranged so as not to physically overlap with each other, while each observation region is arranged to be spaced apart by a predetermined distance in a width direction and a length direction.

5. The observation apparatus of claim 2, wherein the deflection element may be implemented as a mirror, a diffraction grating, a prism, or a metasurface.

6. The observation apparatus of claim 1, wherein the controller controls operation of each image sensor in synchronization with a speed or a position at which the observation target object moves.

7. The observation apparatus of claim 1, wherein the controller is capable of observing an area equal to or greater than a predetermined reference value of the observation target object at once.

8. An observation system comprising:
a stage for placing and moving an observation target object; and
an observation apparatus for measuring optical characteristics of the observation target object by observing an observation region in synchronization with a speed or a position of the observation target object on the stage,
wherein the observation apparatus comprises:
one or more light sources for irradiating light for observation of an observation region;
a plurality of imaging systems, each configured to direct light to the observation region or to the observation region and to a reference mirror provided in the imaging system, to generate object light or interference light including optical characteristics of the observation target object;
a plurality of image sensors for receiving light generated by each imaging system and sensing optical characteristics of the observation target object; and
a controller for controlling operation of each image sensor and observing the observation target object based on sensing values of each image sensor,
wherein each imaging system is implemented such that a size of an image formed on the image sensor is larger than an image of the observation region.

9. An observation apparatus for observing an observation target object, comprising:
one or more light sources for irradiating light for observation of an observation region;
a plurality of imaging systems, each configured to direct light to the observation region or to the observation region and to a reference mirror provided in the imaging system, to generate object light or interference light including optical characteristics of the observation target object;
a plurality of image sensors for receiving light generated by each imaging system and sensing optical characteristics of the observation target object; and
a controller for controlling operation of each image sensor and observing the observation target object based on sensing values of each image sensor,
wherein each imaging system is configured such that each observation region is arranged without gaps in one direction and is spaced apart by a predetermined distance in a direction perpendicular thereto.

10. The observation apparatus of claim 9, wherein the imaging system includes an objective lens.

11. The observation apparatus of claim 10, wherein the image sensor, the objective lens, and the observation region are arranged such that their centers are disposed on the same line or disposed at positions within a predetermined error range from the same line.

12. The observation apparatus of claim 11, wherein the objective lens has an area or diameter greater than a corresponding area or diameter of each of the image sensor and the observation apparatus.

13. The observation apparatus of claim 11, wherein the objective lens is arranged in parallel with an adjacent objective lens in one direction.
